(19) United States
(12) Patent Application Publication
(10) Pub. No.: US 2007/0162545 A1
(43) Pub. Date: Jul. 12, 2007

(54) Method and system for initiating an instant conversation at backend or at front-end over internet

(76) Inventors: Albert Chuan Liu, Troy, MI (US); Song Chen, Guanzhou (CN); Li Yan, Gatineau (CA)

Correspondence Address: LIU, ALBERT CHUAN, 6110 LEDWIN DR., TROY, MI, 48098, US

(21) Appl. No.: 11/318,925

(22) Filed: Dec. 24, 2005

(51) Int. Cl. G06F 17/00

(52) U.S. Cl. 709/204

(57) ABSTRACT

A method and system for initiating an instant conversation by a web user at backend or at front-end. The instant conversation is presented in a web browser over internet. The system supports multiple concurrent instant conversations through wire or wireless devices. The conversation receiver doesn't need to login or install any third party software, and can be any random web user who is browsing the web site.

### BACKGROUND OF THE INVENTION

Internet instant conversation provides a real-time messaging service for users to communicate with other users. In a conventional instant messaging system, users are required to install a client application or sign in to the same server/system with a pre-selected user name and password before sending messages.

Within the existing instant messaging system, only the registered users can start an instant conversation with others. Consequently, without registration, it would be difficult for a user (specially a backend user/site operator) to launch an instant conversation to a site visitor; or it would be difficult to simultaneously send a message to all visitors who are browsing the current web site.

Therefore, it would be desirable to provide techniques for initiating instant conversation between backend user/site operator and any site visitor who is accessing the current web site.

The present invention relates to a method and apparatus for providing online instant conversation at backend or at front-end.

### BRIEF SUMMARY OF THE INVENTION

The present invention provides techniques for performing an instant conversation between backend and front-end web users through wire or wireless devices. In a preferred embodiment of the present invention, the instant conversation can be initiated by backend operator or by front-end site visitor. To receive a text or graph instant conversation, the receiver doesn't need to install any plug-in or third party software; to receive media conversation (audio and video), the conversation sender and receiver need to install flash plug-in or Java applet.

In one embodiment of the disclosed system, a filter service is configured to distinguish online site visitors according to a simple criteria or a complicated business rule.

The system with the present invention provides mechanism broadcasting message to all online visitors who are browsing the current web site. The system can be configured that a backend operator inspects the specific web pages; and the operator can only initiate instant conversation with the front-end visitors who meet the predefined rules.

The following detailed description in conjunction with the accompanying drawings will provide a better understanding of the feature and advantages of the present invention.

### BRIEF DESCRIPTION OF THE DRAWINGS

FIG. 1 is a diagram of a system that can implement online instant conversation features of the present invention;

FIGS. 2-3 are flow charts that illustrate processes for launching instant conversation from backend and from front-end according to various embodiments of the present invention; and

FIG. 4-6 illustrates examples of web site and instant conversation windows, which implements the present invention.

### DETAILED DESCRIPTION OF THE INVENTION

The present invention relates to browser-based instant communication and, in particular, to instant conversation that is activated by backend user/site operator at backend or by any web user at front-end.

The present invention supports text and media instant conversation. To receive text and graphic messages, the receiver doesn't need to install any third-party plug-ins, controls or products; to receive media messages (audio and video), the conversation sender and receiver need to install flash plug-in or Java applet.

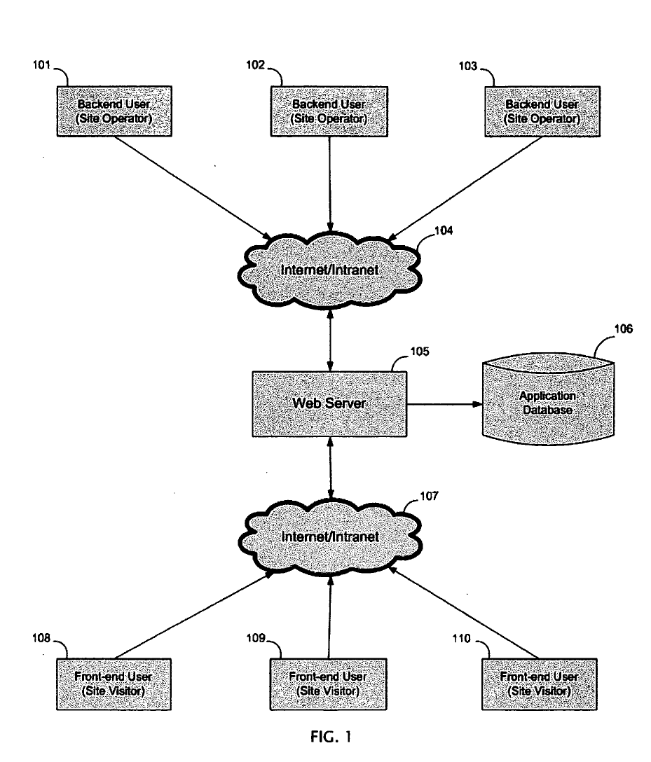

FIG. 1 is a diagram illustrating a system to provide online instant conversation at backend and at front-end. A web server 105 is in communication with an application database 106. Application database 106 is used to store information about the users (including backend users and site visitors) and the site navigation history.

Any backend user/site operator such as 101, 102, 103 and any site visitor such as 108, 109, and 110 can launch an instant conversation over browser. Typically, the web server and browser communicate over the Internet using HTTP/HTTPS or WAP. Only three front-end users/site visitors and three backend users/site operators are shown in FIG. 1 for simplicity.

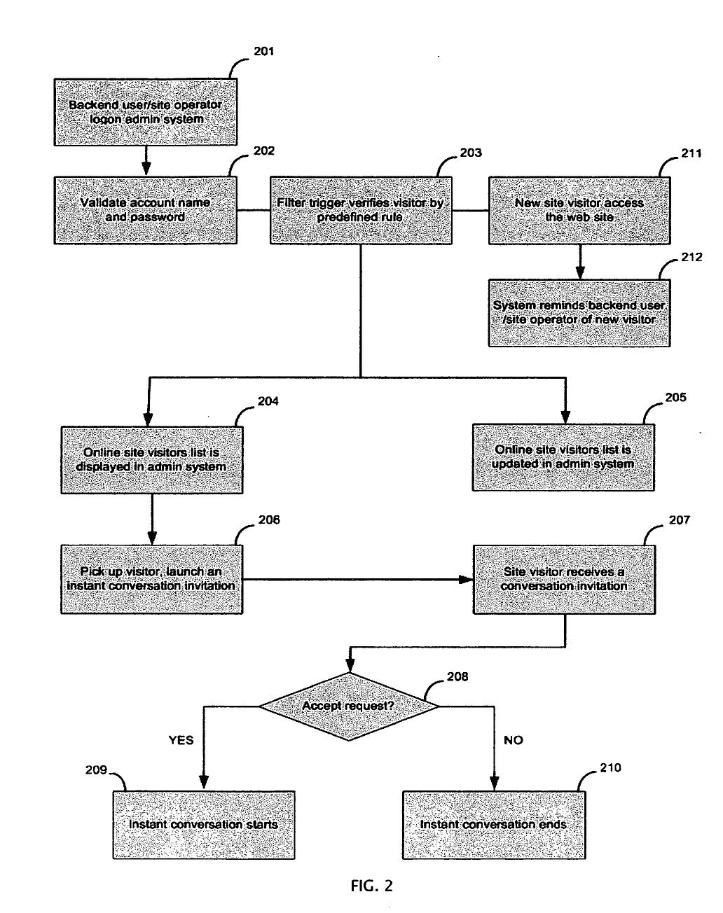

FIG. 2 is a flow chart that outlines a process for activating an instant conversation by site operator at backend according to an embodiment of the present invention. At the first step 201, site operator needs to logon administration system with an account name and password combination. The system validates the user at step 202. In the meantime, filter trigger verifies the online visitors at step 203. Only the visitors whose status meets the predefined rule can be displayed in a visitor list on operator's computer at step 204.

In terms of different business requirements, the filter trigger can be defined in different rules, which could be a simple criteria, such as the time staying onsite, or the geographic location; and it could also be a complicated business pattern, for instance a navigational route in terms of the statistic of successful transaction, and so forth.

When a new site visitor accesses a web page at step 211, the filter trigger verifies the visitor at step 203. If the status of this visitor meets the predefined rule, the said list will be refreshed and updated automatically at step 205. System also reminds backend user by an alert message or sound at step 212. The backend user can pick up any visitor from the list to start a conversation at step 204. At the same time, site visitor receives a conversation invitation at step 207.

At step 208, the site visitor can either accept conversation invitation or reject invitation. If site visitor accept the conversation invitation, the instant conversation will start at step 209. Otherwise, the conversation will end at step 210. The site visitor remains on the same page to continue browsing.

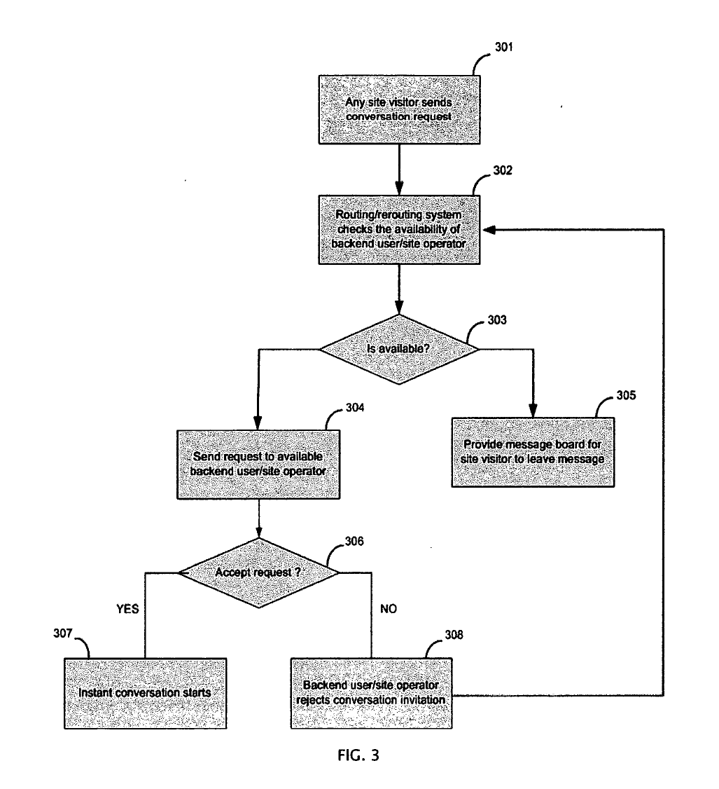

FIG. 3 is a flow chart that illustrates the process for launching an instant conversation by site visitor at front-end according to yet another embodiment of the present invention. At step 301, a site visitor sends a conversation request to the site operator. The connection between front-end and backend server is created. At step 302, the routing/rerouting system checks the availability of site operator.

The system will send a conversation request to the available operator at step 304, if there is available operator. A conversation window is displayed on the available operator's computer. If site operator accepts the request, an instant conversation starts and is shown in a prompt-up chat window at step 307. If site operator rejects the request at step 308, the request will be sent to the next available operator through rerouting system 302.

A message board window will be presented for the site visitor to leave contact information at step 305, if there is no available operator.

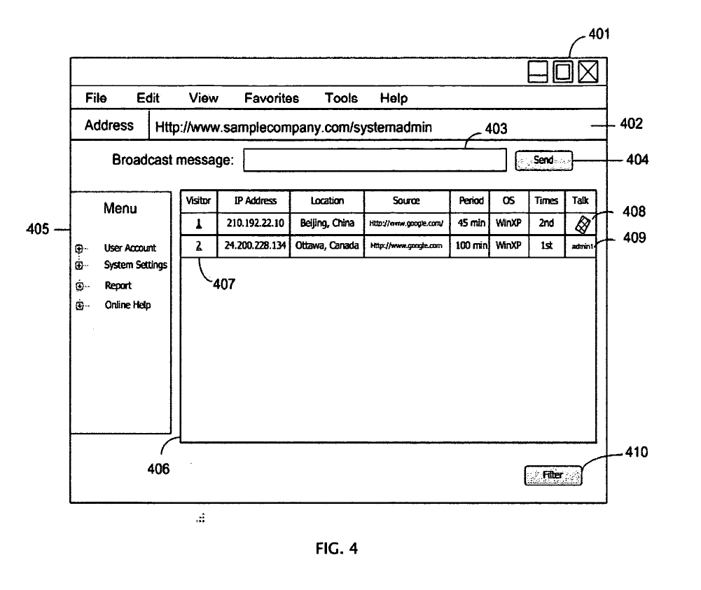

FIG. 4 illustrates an example of how backend user/site operator launches an instant conversation with site visitor. Display window 401 is a screen shot of backend user. The site operator can broadcast message to all site visitors by typing the message in region 403 and then clicking send button 404.

On-line site visitor list is presented in region 406. The brief information of visitor such as IP address, geographic location is displayed in a list. The detailed information about each site visitor including navigational history and user identification can be obtained by clicking hyperlink 407 at the first column.

In one embodiment, the disclosed system of the present invention provides a filter 410 for site operators to inspect site visitor's navigational state and behaviours. In terms of the filter configuration, the system can produce a message or sound to remind backend user/site operator of new site visitors. Alternatively, the visitor list can be configured to only show those who meet the predefined rules; and the site operator can also be configured to monitor specific pages and to launch the specific site visitors.

In another embodiment of the present invention, backend user/site operator can positively send an instant conversation to a specific site visitor through web browser or wireless devices by selecting icon 408. If the visitor is served by another operator, the icon will be replaced by an identity of that user 409.

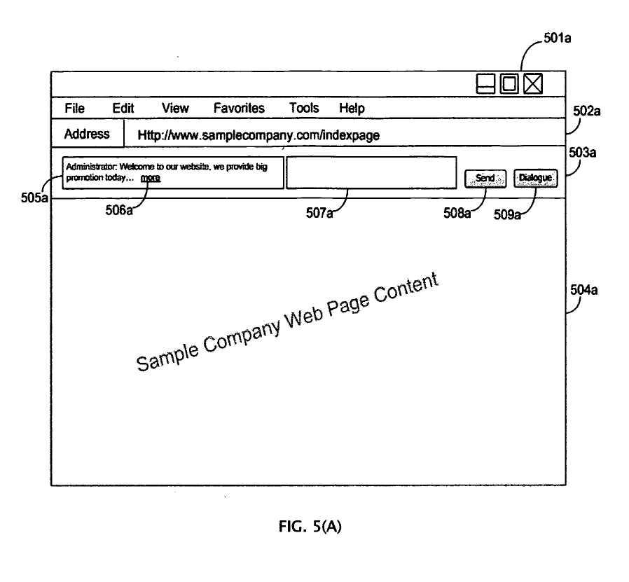

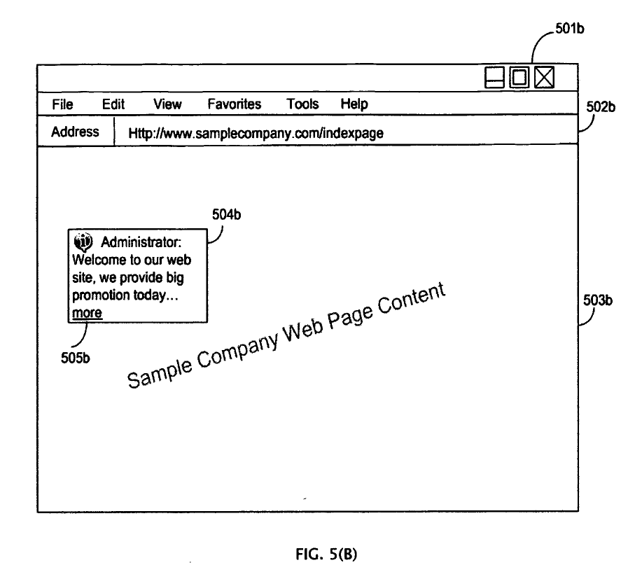

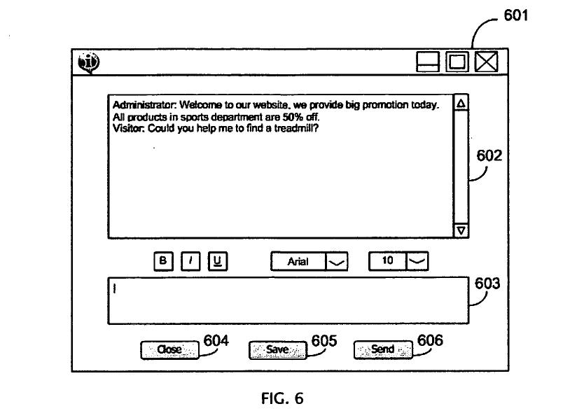

Site visitor can receive or send an instant conversation to backend operator over browser by different means: (1) receiving and sending messages in an embedded frame in the same web page shown in FIG. 5(a); (2) receiving message and conversation invitation in a removable window shown in FIG. 5(b), and starting an instant conversation in a prompt up chat window shown in FIG. 6; (3) system redirecting to a new chat page in the same browser if client prompt up is blocked.

In some embodiment, the disclosed system provides the ability for a backend user/site operator to broadcast messages to all online visitors who are browsing the current site. FIG. 5(a) is a screen shot illustrating how online visitors receive and start an instant conversation at front-end. Window 501a could be any type of browser. Region 504a could display any organizer's web site.

For example, the site operator broadcasts a message: “Welcome to our website, we provide big promotion today . . . ” When site visitors receive the broadcasting message, the background color of region 503a is blinking, and additional sound signal can be set up as well. This message is shown in region 505a in the browser. The hyperlink “more” 506a is provided to review full text. If the site visitor selects hyperlink “more” or click “Dialogue” button 509a, a chat window FIG. 6 with full message will be prompt up on the site visitor's computer.

Site visitor can also activate an instant conversation by directly typing the message in region 507a, and then selecting send option 508a.

FIG. 505(b) is an alternative interface for receiving instant messages sent by backend site operator. Region 504b is a removable block on the web page. Site visitor can activate an instant conversation with backend operator by clicking “more” hyperlink.

FIG. 6 illustrates a chat window 601 which can be launched by site visitor at front-end or by site operator at backend. Users can start instant conversation by typing messages in region 603 and clicking “send” button 606. The conversation history can be saved on client computer in XML, HTML or TEXT format at anytime by selecting “Save” 605.

In order to facilitate and speed up internet-based instant conversation, web push technology is used in conjunction with the present invention, which delivers live data in a light and efficient manner through HTTP and HTTPS.

In order to simplify installation process, the system with current invention is easy to be attached on any web application.

The present invention can be implemented in many fields such as sale product on line. The mechanism of filter service can tell the visitor's desirability of specific product according to a business rule. Therefore, positively launching an instant conversation with any potential site visitor (or customer), can help to seize more business opportunities.

Furthermore, the present invention also offers a complete statistical report and chart on site navigation history, and on visitors' behaviours, which facilitates marketing optimization especially in e-commerce industry.

While the invention has been described with respect to specific embodiments, it will be apparent that certain changes and modifications may be practiced within the scope of the appended claims. It should be noted that there are many alternative ways of implementing both process and apparatus of the present invention. Thus, the present invention is not to be limited to the details given herein, but the invention is intended to cover all modifications and equivalents within the scope of the following claims:

What is claimed is:

1. A method and system comprising: simultaneously initiating a single or multiple instant conversations at backend (by site operator) or at front-end (by any site visitor), supporting instant conversation in text, graphic, and media format.

2. The method and system of claim 1 further comprising: initiating instant conversation with any web visitor who is browsing the current web site through HTTP (Hyper Text Transfer Protocol) or WAP (Wireless Application Protocol).

3. The method and system of claim 1 further comprising: identifying backend operator in a web based application or window application, initiating instant conversation by either backend operator or front-end web user, wherein the front-end web user is browsing the current web site.

4. The method and system of claim 1 wherein initiating instant conversation through: prompting up an invitation message in a removable window; showing the invitation message in an embedded frame in the page; or redirecting to the invitation page in the same browser.

5. The method and system of claim 1 further comprising: a web site tracking mechanism, a mechanism of routing and rerouting message, a user profile management system and a filter service.

6. The method and system of claim 5, wherein said tracking mechanism is further operative to observing the site navigational state and site visitor's activities in any time slice.

7. The method and system of claim 5, further operative to reminding the site operator of site visitors who reach the predefined rule in a filter mechanism. The system can be configured that different backend operator inspects different web pages and activate instant conversation with site visitor who is browsing the specific pages.

8. The method and system of claim 5, wherein filter service provides ability of creating simple criteria and complicated business pattern as a rule.

9. The method and system of claim 5, further comprising a mechanism for generating statistical reports about site visitor's desirability, site visitor's navigational history and site access state.
